(19) United States
(12) Patent Application Publication
(10) Pub. No.: US 2026/0093806 A1
(43) Pub. Date: Apr. 2, 2026

(54) A METHOD FOR GENERATING KILL CHAINS AND RECOMMENDING REMEDIATION ACTION

(71) Applicant: CybrIQ Solutions, Inc., Warrenton, VA (US)

(72) Inventor: Stephen M. George, Bristol, TN (US)

(21) Appl. No.: 19/344,865

(22) Filed: Sep. 30, 2025

Related U.S. Application Data
(60) Provisional application No. 63/701,283, filed on Sep. 30, 2024.

(51) Int. Cl. G06F 21/55; G06F 21/57

(52) U.S. Cl. CPC G06F 21/554; G06F 21/577

(57) ABSTRACT

A method includes, for each vulnerability in a set of vulnerabilities: deriving a correlation between the vulnerability and an attack technique based on language signals detected in descriptions of the vulnerability; constructing a vulnerability module defining the attack technique and representing the vulnerability; detecting a second vulnerability preceding exploitation of the vulnerability in the corpus of threat intelligence; defining the second vulnerability as an input vulnerability in the vulnerability module; detecting a third vulnerability succeeding exploitation of the vulnerability in the corpus of threat intelligence; defining the third vulnerability as an output vulnerability in the vulnerability module; interpreting an access tier of the vulnerability based on characteristics of the attack technique; accessing a vulnerability risk score for the vulnerability; interpreting a mitigation technique for the attack technique; and annotating the vulnerability module with the access tier, the vulnerability risk score, and the mitigation technique.

### CROSS-REFERENCE TO RELATED APPLICATIONS

This Application claims the benefit of U.S. Provisional Application No. 63/701,283, filed on 30 Sep. 2024, which is incorporated in its entirety by this reference.

### TECHNICAL FIELD

This invention relates generally to the field of cybersecurity and kill chain construction and more specifically to a new and useful method for kill chain construction and remediation recommendation.

### BRIEF DESCRIPTION OF THE FIGURES

FIG. 1 is a flowchart representation of a method; and

FIG. 2 is a schematic representation of the method.

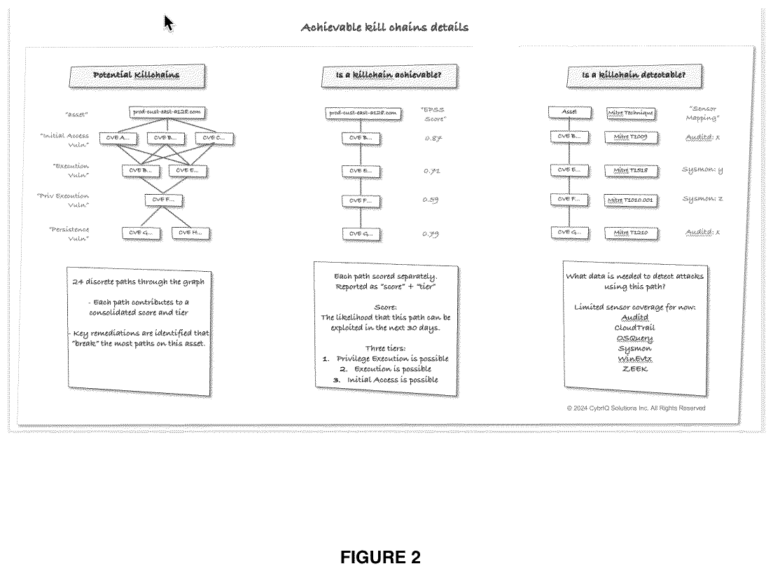

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method: Threat Intelligence+Vulnerability Modules

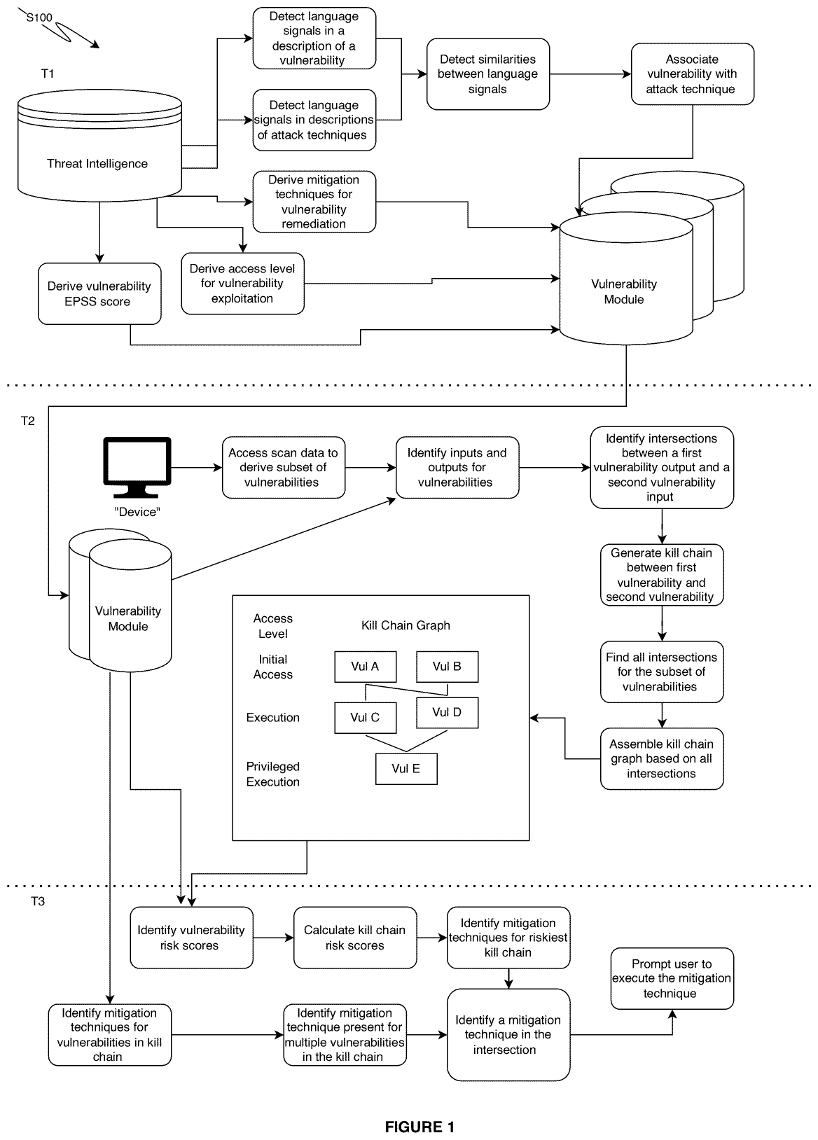

As shown in FIG. 1, a method S100 includes accessing a corpus of threat intelligence representing a set of vulnerabilities and a set of attack techniques and, for each vulnerability in the set of vulnerabilities: deriving a correlation between the vulnerability and an attack technique, in the set of attack techniques, based on language signals detected in descriptions of the vulnerability and the attack technique; constructing a vulnerability module, in a set of vulnerability modules, defining the attack technique and representing the vulnerability; detecting a second vulnerability, in the set of vulnerabilities, preceding exploitation of the vulnerability in the corpus of threat intelligence; defining the second vulnerability as an input vulnerability in the vulnerability module; detecting a third vulnerability, in the set of vulnerabilities, succeeding exploitation of the vulnerability in the corpus of threat intelligence; defining the third vulnerability as an output vulnerability in the vulnerability module; interpreting an access tier of the vulnerability based on characteristics of the attack technique correlated with the vulnerability; accessing a vulnerability risk score for the vulnerability from the corpus of threat intelligence; interpreting a mitigation technique for the attack technique from the corpus of threat intelligence; deriving a set of device inclusion characteristics correlated with exploitation of the vulnerability via the attack technique from the corpus of threat intelligence; and annotating the vulnerability module with the access tier, the vulnerability risk score, the mitigation technique, and the set of device inclusion characteristics.

### 1.1 Method: Kill Chain Graph Construction

The method S100 also includes: selecting a device connected to a computer network; accessing a set of characteristics of the device; isolating a subset of vulnerability modules, in the set of vulnerability modules, associated with device inclusion characteristics corresponding to the set of characteristics of the device; populating a kill chain graph for the device with a constellation of nodes representing the subset of vulnerability modules; sorting the constellation of nodes into tiers based on access tier defined in corresponding vulnerability modules in the subset of vulnerability modules; selectively connecting nodes in the kill chain graph with edges based on alignment of input vulnerabilities and output vulnerabilities, defined in corresponding vulnerability modules in the subset of vulnerability modules, of nodes in adjacent tiers in the kill chain graph; and identifying a set of kill chains for the device, each kill chain defining a unique continuous pathway through the kill chain graph.

### 1.2 Method: Kill Chain Scoring

The method S100 also includes, for each kill chain in the set of kill chains: calculating a composite kill chain score for the kill chain based on vulnerability risk scores indicated in vulnerability modules associated with nodes in the kill chain.

Alternatively, the method can include, for each kill chain in the set of kill chains: calculating a set of vulnerability risk scores for nodes in the kill chain based on characteristics (e.g., type, posture, software and firmware configurations) of the device, predicted impact to the computer network, likelihood of exploitation on the device, and exploitability of the device; and calculating a composite kill chain score for the kill chain based on the set of vulnerability risk scores.

### 1.3 Variation: Kill Chain Deactivation by Device Configuration

In one variation, the method S100 further includes: for each vulnerability in the set of vulnerabilities, deriving a set of device exclusion characteristics; annotating the vulnerability module with the set of device exclusion characteristics; accessing a set of configurations for a second device connected to the computer network; and deactivating a subset of kill chains, each kill chain in the subset of kill chains containing a node corresponding to a vulnerability module defining a device exclusion characteristic corresponding to a configuration in the set of configurations of the device.

### 1.4 Method: Single-device Target Kill Chain+Mitigation Technique Selection

The method S100 also includes identifying a set of mitigation techniques indicated in vulnerability modules associated with nodes in each kill chain in the set of kill chains.

The method S100 further includes, for each mitigation technique in the set of mitigation techniques: accessing a resource cost estimate for implementing the mitigation technique on the device (e.g., based on a software deployment cost, software update cost, or human involvement duration); identifying a subset of kill chains, in the set of kill chains, containing a node associated with a vulnerability module indicating the mitigation technique; calculating a risk reduction value for the mitigation technique based on a combination of composite kill chain scores for the subset of kill chains; and calculating a normalized risk reduction value for executing the mitigation technique on the device based on the risk reduction value and the resource cost estimate.

The method S100 further includes identifying a particular mitigation technique, in the set of mitigation techniques, associated with a greatest normalized risk reduction value; generating a prompt to execute the particular mitigation technique on the device; and serving the prompt to security personnel affiliated with the computer network.

### 1.5 Method: Multi-device Target Kill Chain+Mitigation Technique Selection

One variation of the method S100 includes, for each device in a population of devices connected to the computer network: generating a kill chain graph for the device; identifying a set of kill chains for the device; and calculating a set of composite kill chain scores for the set of kill chains for the device.

This variation of the method S100 also includes identifying a set of mitigation techniques indicated in vulnerability modules associated with nodes in each kill chain in the set of the kill chains for the population of devices.

This variation of the method S100 further includes, for each mitigation technique in the set of mitigation techniques: accessing a resource cost estimate for implementing the mitigation technique across the population of devices; identifying a subset of kill chains, in the set of kill chains, containing a node associated with a vulnerability module indicating the mitigation technique; calculating a risk reduction value for the mitigation technique based on a combination of composite kill chain scores for the subset of kill chains; and calculating a normalized risk reduction value for the mitigation technique, executed across the population of devices, based on the risk reduction value and the resource cost estimate.

The method S100 further includes: identifying a particular mitigation technique, in the set of mitigation techniques, associated with a greatest normalized risk reduction value; identifying a subset of devices, in the population of devices, associated with kill chains containing nodes associated with vulnerability modules indicating the mitigation technique; generating a prompt to execute the particular mitigation technique on the subset of devices; and serving the prompt to security personnel affiliated with the computer network.

### 1.6 Variation: Kill Chain Graph Filtering

In one variation, the method S100 includes: populating a kill chain graph with a constellation of nodes representing the set of vulnerability modules; sorting the constellation of nodes into tiers based on access tiers defined in corresponding vulnerability modules in the subset of vulnerability modules; selectively connecting nodes in the kill chain graph with edges based on alignment of input vulnerabilities and output vulnerabilities, defined in corresponding vulnerability modules in the set of vulnerability modules, of nodes in adjacent tiers in the kill chain graph; and identifying a set of kill chains in the kill chain graph, each kill chain defining a unique continuous pathway through the kill chain graph.

In this variation, the method S100 further includes, for a device connected to a network associated with an organization: accessing a set of device characteristics; generating a first kill chain graph by filtering vulnerabilities in the kill chain graph based on the device characteristics and device inclusion characteristics defined in corresponding vulnerability modules in the set of vulnerability modules; accessing a subset of vulnerabilities identified on the device; and deactivating a subset of nodes, each node corresponding to a vulnerability module absent from the subset of vulnerabilities.

### 2. Applications

Generally, Blocks of the method S100 can be executed by a computer system (e.g., a remote computer system or server outside of a computer network) to: ingest threat intelligence representing historical vulnerabilities previously exploited on a population of devices (e.g., endpoint devices or other assets) (e.g., “CVE data”) and attack techniques implemented by attackers to exploit these historical vulnerabilities (e.g., “MITRE data”); to autonomously derive correlations between these historical vulnerabilities and attack technique instances; to interpret characteristics of exploited devices, risk characteristics, and mitigation techniques for these historical vulnerabilities and attack techniques; to identify preceding exploited vulnerabilities and subsequent unlocked vulnerabilities for these historical vulnerabilities; to characterize access tiers of these historical vulnerabilities; to construct one vulnerability module for each historical vulnerability attack technique pair (or set, group); and to augment these vulnerability modules with corresponding device characteristics, risk characteristics, mitigation techniques, preceding exploited vulnerabilities, and subsequent unlocked vulnerabilities, and/or access tier.

The computer system can then: select a particular device on a computer network; retrieve characteristics of the device (e.g., make, model, operating system, user posture, installed software and firmware, installed patches and updates) for a particular device in a network of devices, access a subset of vulnerabilities present on the device; generate a kill chain graph based on the subset of vulnerabilities and a vulnerability module for each vulnerability in the subset of vulnerabilities; derive a kill chain risk score for each kill chain (or “access chain”) in the kill chain graph; and recommend a particular mitigation technique resulting in the greatest amount of risk reduction for the kill chain graph based on the kill chain risk score and mitigation techniques in the vulnerability modules.

In particular, the system can execute Blocks of the method S100 to: access a corpus of threat intelligence, including a set of vulnerabilities (e.g., weaknesses in security systems of a particular device) including, for each vulnerability, a vulnerability risk score and a vulnerability description and a set of attack techniques representing methods of exploitation of a particular vulnerability; and derive a correlation between a first vulnerability in the set of vulnerabilities and a first attack technique in the set of attack techniques. Therefore, the system can fuse threat intelligence data to correlate a first vulnerability to an associated attack technique representing a method of exploiting the first vulnerability, enabling a user to derive insights for a likelihood of the first vulnerability being exploited by a bad actor (or “hacker”) based on threat intelligence for attack techniques available to bad actors.

Additionally, the system can: access a subset of vulnerabilities of a particular device connected to a computer network, such as from historical scan data from a set of sensors on the device (or the computer network); and assemble the subset of vulnerabilities into a set of kill chains (or “a kill chain graph”) based on the subset of vulnerabilities and device characteristics for the particular device. More specifically, the system can, for each vulnerability in the subset of vulnerabilities: access a vulnerability module associated with the vulnerability; identify a second input vulnerability, such as a second vulnerability preceding exploitation of the vulnerability based on a first attack technique leveraged by a bad actor to exploit the vulnerability, from the vulnerability module; and identify a third output vulnerability, such as a third vulnerability succeeding exploitation of the vulnerability based on a second attack technique that can enable a bad actor to exploit (and/or access and/or “unlock”) the third vulnerability on the device. The system can then: identify an intersection between input vulnerabilities and output vulnerabilities to identify connections (or “pathways”) between vulnerabilities on the device; and aggregate the connections into a set of kill chains, or a kill chain graph. Therefore, the system can generate a kill chain graph unique to the device based on the subset of vulnerabilities identified on the device and characteristics of those vulnerabilities.

Additionally, in response to generating the kill chain graph, the system can, for each kill chain in the kill chain graph: generate a kill chain risk score; and identify and recommend a mitigation technique based on the kill chain risk score and characteristics of the vulnerabilities in the kill chain. In particular, the system can: access a vulnerability risk score, such as from the vulnerability module, for each vulnerability in a first kill chain; and aggregate (e.g., sum, average) the vulnerability risk scores to generate a kill chain risk score. The system can then: identify a set of device characteristics (e.g., internet connection, user profile, sensitivity of data stored on the device, computational load availability); identify a set of mitigation techniques based on the vulnerability modules for vulnerability in the kill chain; and identify an optimal mitigation technique for kill chain remediation based on the kill chain risk score, the set of device characteristics, and the set of mitigation techniques. For example, the system can select (or recommend) a mitigation technique based on identifying the mitigation technique in multiple vulnerability modules, indicating the mitigation technique can remediate (or “patch”) multiple vulnerabilities in the kill chain (thus “breaking”the kill chain).

In another example, the system can: access data representing resource cost (e.g., labor costs, software installation and/or purchase cost, management availability) for a particular mitigation technique; and, in response to a particular mitigation technique expressing high reductions of risk for relatively low resource cost, prompt a user to prioritize the mitigation technique.

Therefore, rather than independently assessing each vulnerability associated with the device, the system can implement methods of vulnerability management to: identify vulnerabilities that can enable a bad actor to gain deeper access into a security network (e.g., jump access levels, access a second device from a first device, access sensitive data from a low-priority vulnerability); and identify mitigation techniques that enable a user, associated with the device, to address and remediate high-risk vulnerabilities in the context of the constellation of vulnerabilities represented on the particular device and with minimal cost burden for the organization.

The method S100 is described herein as executed by a remote computer system. However, Blocks of the method S100 can be executed by one or more entities accessing the network, by a local computer system, or by any other computer system—hereinafter a “system.”

### 3. Terminology

A “vulnerability” is referred to herein as a weakness on an asset or device, such as a security failure or a gap in security measures identified by a scanner on a computer network (e.g., a CVE, a CWE).

An “attack technique” is referred to herein as a method of exploiting a vulnerability, such as a cyberattack technique implemented by a bad actor to gain access (or execution privileges) to a device and/or files on the device by exploiting a vulnerability.

An “access tier” is referred to herein as a vulnerability classification, such as a classification based on a type of access a bad actor may gain by exploiting the vulnerability.

A “mitigation technique” is referred to herein as a method of vulnerability remediation, such as a patch, a defense mechanism, or another action security personnel may take to resolve a vulnerability.

A “vulnerability module” is referred to herein as a data container representing attributes associated and/or correlated with a vulnerability, such as attributes derived from the corpus of threat intelligence.

A “kill chain” is referred to herein as an access chain, such as a connection between vulnerabilities or a sequence of vulnerabilities which can be exploited by a bad actor.

A “kill chain graph” is referred to herein as an interconnected graph representing a set of kill chains, such as a set of kill chains identified on a particular device.

A “node” is referred to herein as a representation of a vulnerability or a vulnerability module on a kill chain.

### 4. Threat Intelligence

Generally, the system can access a threat intelligence database including: a set of vulnerabilities, such as security flaws in software or hardware for a device that a hacker (or “bad actor”) may exploit to gain unauthorized access to a device and/or files on the device, including a vulnerability risk score associated with a vulnerability ID; a set of attack techniques, such as a method of exploiting a particular vulnerability (e.g., SQL injection); and a set of mitigation techniques for each attach technique in the set of attack techniques.

In particular, the system can access the corpus of threat intelligence, such as from a threat intelligence database, including: descriptions of vulnerabilities (e.g., a set of device characteristics for a device that can exhibit a particular vulnerability, a set of potential mitigation techniques, a vulnerability risk score); descriptions of attack techniques (e.g., methods or tactics implemented by a bad actor); and descriptions of mitigation techniques (e.g., patches, defense mechanisms) associated with vulnerabilities and/or attack techniques.

### 5. Data Normalization

Generally, the system can, for each vulnerability in the set of vulnerabilities: derive a correlation between the vulnerability and attack techniques; derive an access tier based on a description of the vulnerability from the threat intelligence; access mitigation techniques associated with rectification of the vulnerability; access a vulnerability risk score associated with a likelihood of exploitation for the vulnerability; and annotate (or populate) a vulnerability module, associated with the vulnerability, with the correlation, the access tier, mitigation techniques, and the vulnerability risk score.

### 5.1 Vulnerability and Attack Technique Correlation

Generally, the system can generate a correlation between the vulnerability in the set of vulnerabilities and a first attack technique in the set of attack techniques based on a similarity between descriptions of the vulnerability and the first attack techniques from the corpus of threat intelligence.

In one implementation, for a first vulnerability in the set of vulnerabilities, the system can: vectorize a description of the first vulnerability by detecting language signals, such as by implementing natural language processing models or natural language understanding models tuned to particular language concepts - to detect words or phrases in the description of the first vulnerability; and transforming the language signals into a vector, such as by implementing sentence tokenization techniques. The system can then, for a first attack technique in the set of attack techniques: vectorize a description of the first attack technique by implementing similar methods and techniques described herein to detect similar language signals; and, in response to detecting an angular offset falling below an angular offset threshold (e.g., 45°), correlating the first vulnerability to the first attack technique.

Additionally or alternatively, the system can correlate a vulnerability to an attack technique by: projecting a set of vulnerability vectors and a set of attack technique vectors into an n-dimensional hyperplane; and, in response to identifying a distance between a first vulnerability vector and a first attack technique vector falling below a distance threshold, correlating the first vulnerability and the first attack technique.

Accordingly, the system can derive a correlation between a first vulnerability and a first attack technique, indicating that a particular vulnerability can be exploited by the associated (or “correlated”) attack technique.

### 5.2 Vulnerability Access Tiers

In one implementation, the system can derive an access tier (e.g., initial access, privileged execution) based on a description of the vulnerability from the threat intelligence.

For example, for a first vulnerability in the set of vulnerabilities, the system can derive an access tier by: deriving a set of inputs to the vulnerability based on attack techniques correlated with exploiting the vulnerability; deriving a set of outputs from the vulnerability (e.g., actions a bad actor may take in response to exploiting the vulnerability) based on attack techniques associated with escalation (e.g., attempts to gain access deeper into the computer network), such as an attempt to exploit a second vulnerability; and deriving the access tier based on the set of input and the set of outputs.

Therefore, the system can derive (or assign) a first vulnerability to an access tier based on attack techniques that a bad actor may use to exploit the vulnerability and/or attack techniques that a bad actor may use in response to exploiting the first vulnerability to gain access to a second vulnerability.

### 5.3 Vulnerability Module Aggregation

In one implementation, the system can generate a set of vulnerability modules, for the set of vulnerabilities, representing attributes of each vulnerability based on the threat intelligence database.

In one implementation, for a first vulnerability in the set of vulnerabilities, the system can: generate a module for the first vulnerability; and populate the module with attack techniques correlated with the first vulnerability, an access tier associated with the first vulnerability, a vulnerability risk score, and device inclusion and/or exclusion characteristics (e.g., device type, internet connection, applications installed on the device, device configuration, device hardware, device software) associated with the first vulnerability.

Additionally or alternatively, the system can implement a model (e.g., an AI model): to identify a first entry, in the threat intelligence database, representing a vulnerability; to identify a second entry representing a vulnerability risk score; to identify a third entry representing an attack technique; to correlate the first entry, the second entry, and the third entry based on similarities between the entries; and to implement methods and techniques described herein to generate a vulnerability module and populating the vulnerability module with the first entry, the second entry, and the third entry.

Therefore, the system can generate a set of vulnerability modules, representing a set of vulnerabilities, based on threat intelligence, to derive insights for each vulnerability in the set of vulnerabilities, such as attack techniques associated with the vulnerability, device access levels associated with a bad actor exploiting the vulnerability, and mitigation techniques associated with vulnerability remediation.

### 6. Single Device Monitoring+Actions

Generally, for a first device in a network of devices, the system can: access a set of device characteristics, including a subset of vulnerabilities present on the first device; access a subset of vulnerability modules representing the subset of vulnerabilities; generate a kill chain graph by generating connections between nodes representing vulnerabilities in the subset of vulnerabilities; calculate a kill chain risk score for each kill chain in the kill chain graph; and prompt a user to execute a mitigation technique based on the subset of vulnerabilities and the kill chain risk score.

### 6.1 Device Selection+Data Access

Generally, the system can select a device, in a network of devices, such as a device associated with a computer network of an organization.

In one implementation, the system can access a list of devices on a network, such as a device inventory, including a set of device characteristics (e.g., internet connection, user profile, port access, data sensitivity) for each device in the list of devices.

For example, the system can access a list of devices on a network in response to a user uploading a device inventory, including a set of device characteristics, to the system.

In one implementation, in response to accessing a list of devices on a network, the system can, for each device in the list of devices: access a set of device characteristics, such as by querying the device list for the set of device characteristics; and query security sensors on the device for security tool configurations. For example, the system can: access a software inventory list, such as a network-wide software list representing an aggregation of software tools on the devices; and access a set of user profiles associated with the list of devices, including a list of software access associated with each user profile.

In one implementation, the system can: select a device, from the list of devices; query the device for a device configuration representing hardware configuration; query the software inventory list for a list of software installed on the device; and generate a device profile representing a set of device characteristics including the device configuration and the list of software installed on the device.

In another implementation, the system can: select a device from the list of devices; and query a set of sensors deployed on the network, such as querying the sensors directly and/or via an API, for vulnerabilities currently present on the device.

The system can then, in response to selecting a device and generating a device profile: query the device for a set of scan data, such as from a third-party vulnerability detection scan, to access a subset of vulnerabilities on the device based on the device profile.

### 6.2 Kill Chain Construction

Generally the system can construct a kill chain by, for a first device in the network: accessing a set of device characteristics (e.g., internet connection, user profile, port access, data sensitivity) including a subset of vulnerabilities present on the device; for each vulnerability in the subset of vulnerabilities, accessing the associated module; populating a kill chain with a constellation of nodes representing the subset of vulnerabilities; classifying nodes, representing vulnerabilities in the subset of vulnerabilities, into access tiers based on the vulnerability module for each vulnerability; identifying input vulnerabilities; identifying output vulnerabilities; and, based on input vulnerabilities and output vulnerabilities, deriving discrete pathways (or “connections”) between vulnerabilities to generate a kill chain graph.

In one implementation, the system can construct a kill chain by, for a first vulnerability in the subset of vulnerabilities: accessing a first vulnerability module associated with the first vulnerability; populating a kill chain with a first node, representing the first vulnerability, at the access tier associated with the first vulnerability based on the first vulnerability module; identifying a second vulnerability in the subset of vulnerabilities representing an input vulnerability to the first vulnerability, indicating exploitation of the second vulnerability can enable access to the first vulnerability on the device; populating the kill chain with a second node representing the second vulnerability; generating a first edge (or “connection”) between the first node and the second node; identifying a third vulnerability in the subset of vulnerabilities representing an output vulnerability from the first vulnerability; populating the kill chain with a third node representing the third vulnerability; and generating a second edge between the first vulnerability and the third vulnerability.

For example, the system can generate pathways between vulnerabilities based on a second vulnerability output in a first access tier (e.g., initial access) enabling a first input for a first vulnerability in a second access tier (e.g., execution), the second access tier representing a deeper access level in the device than the first tier.

Accordingly, the system can generate a set of kill chains by implementing methods and techniques described herein for each vulnerability in the subset of vulnerabilities identified on a particular device in the computer network.

Therefore, the system can implement path enumeration techniques to identify edges (or “pathways”) between nodes representing vulnerabilities on a device to generate a kill chain representing stages of a potential cybersecurity attack.

### 6.2.1 Kill Chain Graph Construction+Enumeration

In one implementation, the system can construct a kill chain graph by, for a first kill chain in a set of kill chains: identifying an intersection between a first set of nodes associated with the first kill chain and a second set of nodes associated with a second kill chain in the set of kill chains; and aggregating the first kill chain and the second kill chain into a kill chain graph.

For example, for a first kill chain including a first node at a first access tier and a second node at a second access tier, the system can: identify a second kill chain including the first node at the first access tier and a third node at the second access tier; and aggregate the first kill chain and the second kill chain into a kill chain graph based on the intersection between the first kill chain and the second kill chain at the first node.

Accordingly, the system can generate a kill chain graph by implementing methods and techniques described herein for each kill chain in the set of kill chains identified on a particular device in the computer network.

### 6.2.2 Device Exclusion Characteristics

In one variation, the method further includes: for each vulnerability in the set of vulnerabilities, deriving a set of device exclusion characteristics associated with and annotating the vulnerability module with the set of device exclusion characteristics; accessing a set of configurations for a second device connected to the computer network; and deactivating a subset of kill chains, each kill chain in the subset of kill chains containing a node corresponding to a vulnerability module defining a device exclusion characteristic corresponding to a configuration in the set of configurations of the device.

For example, the system can: access a set of device exclusion characteristics from the corpus of threat intelligence representing a device configuration incompatible with a first vulnerability (e.g., a particular device configuration configured to eliminate a particular vulnerability on the device); annotate a first vulnerability module, associated with the first vulnerability, with the set of device exclusion characteristics; and, in response to detecting a device exclusion characteristic in the set of device exclusion characteristics on a device and in response to detecting a first node, representing the first vulnerability, in a first kill chain associated with the device, removing the first node from the kill chain. Therefore the system can dynamically update a kill chain graph for a particular device responsive to updates to a device configuration.

### 6.3 Kill Chain Risk Scoring

Generally, the system can: calculate a kill chain risk score for each kill chain in a kill chain graph; and classify each kill chain in the kill chain graph based on the kill chain risk score.

In one implementation, the system can, calculate a kill chain risk score for a first kill chain in a kill chain graph by: accessing a set of vulnerability risk scores (e.g., indicating how likely a vulnerability is to be exploited by a bad actor) for each vulnerability in the first kill chain; accessing a set of device characteristics (e.g., user profile, internet access, frequency of use, security/risk/importance of data on that device, interdevice connections); deriving a device risk score based on the device characteristics; and aggregating (e.g., summing, averaging) the set of vulnerability risk scores and the device risk score to generate the kill chain risk score.

In this implementation, the system can then classify the first kill chain into a risk category based on kill chain risk scores. In one example, the system can classify a kill chain as a high risk based on a high kill chin risk score and/or in response to the kill chain risk score exceeding a kill chain risk threshold. In another example, the system can classify a kill chain as a low risk kill chain in response to the kill chain risk score falling below the kill chain risk threshold.

Additionally or alternatively the system can, for each kill chain in the set of kill chains: calculate a set of vulnerability risk scores for nodes in the kill chain based on characteristics (e.g., type, posture, software and firmware configurations) of the device, predicted impact to the computer network, likelihood of exploitation on the device, and exploitability of the device; and calculate a composite kill chain score for the kill chain based on the set of vulnerability risk scores.

The system can implement methods and techniques described herein to calculate a kill chain risk score and assign a risk classification for each kill chain in a kill chain graph.

### 6.4 Risk Minimization+Impact Scoring+Action Selection

In one implementation, for a first kill chain (e.g., a high risk kill chain), the system can: identify a vulnerability in the first kill chain, such as a vulnerability exhibiting the highest likelihood to be exploited (e.g., highest vulnerability risk score); identify a mitigation technique associated with the vulnerability (e.g., from the module associated with the vulnerability); and prompt a user, associated with the first device, to execute the mitigation technique.

For example, for each kill chain in the kill chain graph, the system can: identify a particular mitigation technique, in the set of mitigation techniques, associated with a greatest normalized risk reduction value based on a composite kill chain risk score and an impact score associated with the particular mitigation technique; generate a prompt to execute the particular mitigation technique on the device; and serve the prompt to security personnel affiliated with the computer network.

In a similar example, the system can: extract a set of mitigation techniques from a set of vulnerability modules associated with the constellation of nodes in the kill chain graph; calculate an impact score, representing an aggregate risk reduction for the device, for each mitigation technique in the set of mitigation techniques based on an intersection between mitigation techniques and device characteristics (e.g., a user associated with a device, internet access, port availability, data sensitivity); rank (or “sort”) the mitigation techniques based on the impact score for each mitigation technique; generate a visualization representing the ranking of the mitigation techniques and prompting a user to execute the mitigation technique(s) with the highest impact scores; and present the user with the visualization.

Accordingly, the system can identify a mitigation technique with the highest impact score; and recommend the mitigation technique to rectify the most vulnerabilities with minimum effort and/or input from a user and/or an organization associated with the device.

Therefore, the system can identify a singular action that remediates the greatest count and/or frequency of kills chains for a device, thereby enabling a user to implement a single mitigation technique resulting in the greatest amount of risk reduction with a minimum level of computational load.

### 6.5 Risk Minimization Normalized by Resource Consumption

In one implementation, the system can: identify a set of mitigation techniques from the set of nodes in the kill chain graph; calculate an impact score, representing an aggregate risk reduction for the device, for each mitigation technique in the set of mitigation techniques based on an intersection between mitigation techniques and device characteristics (e.g., a user associated with a device, internet access, port availability, data sensitivity); access a resource cost estimate for each mitigation technique; normalize the impact score relative to the resource cost to generate a normalized impact score; rank (or “sort”) the mitigation techniques based on the normalized impact score for each mitigation technique; generate a visualization representing the ranking of the mitigation techniques and prompting a user to execute the mitigation technique(s) with the highest normalized impact scores; and present the user with the visualization.

For example, the system can generate a normalized impact score for a first mitigation technique by: accessing a first impact score for the first mitigation technique; calculating a resource cost (e.g., financial burden, time allocation, device restart) for the first mitigation technique based on attributes of the first mitigation technique, such as a software purchase price, a software installation time and/or a computational load; and dividing the first impact score by the resource cost to generate a normalized impact score.

In a similar example, the system can: access a resource cost estimate for implementing the mitigation technique on the device (e.g., based on a software deployment cost, software update cost, or human involvement duration); identify a subset of kill chains, in the set of kill chains, containing a node associated with a vulnerability module indicating the mitigation technique; calculate a risk reduction value for the mitigation technique based on a combination of composite kill chain scores for the subset of kill chains; and calculate a normalized risk reduction value for executing the mitigation technique on the device based on the risk reduction value and the resource cost estimate.

Therefore, the system can present a user with a mitigation technique to implement based on resource allocation and/or availability of personnel to execute a particular mitigation technique, thereby enabling a user to implement a single mitigation technique resulting in the greatest amount of risk reduction with a minimum level of computational load.

### 7. Multi-Device Network Monitoring+Actions

In one implementation the system can implement methods and techniques described herein for each device on a computer network (e.g., an organization computer network) to generate a set of kill chain graphs.

For example, the system can, for each device in a population of devices: access a set of device characteristics (e.g., internet connection, user profile, port access, data sensitivity) including a subset of vulnerabilities present on the device; for each vulnerability in the subset of vulnerabilities, accessing the associated module; populate a kill chain graph for the device with a constellation of nodes representing the subset of vulnerability modules; sort the constellation of nodes into tiers based on access tier defined in corresponding vulnerability modules in the subset of vulnerability modules; selectively connect nodes in the kill chain graph with edges based on alignment of input vulnerabilities and output vulnerabilities, defined in corresponding vulnerability modules in the subset of vulnerability modules, of nodes in adjacent tiers in the kill chain graph; identify a set of kill chains for the device, each kill chain defining a unique continuous pathway through the kill chain graph; and, for each kill chain in the kill chain graph, calculate a kill chain risk score based on a set of vulnerability risk scores, associated with the subset of vulnerabilities, and a set of device characteristics associated with the device, and identify a set of mitigation techniques based on the vulnerability modules associated with the subset of vulnerabilities.

In this implementation, the system can: access a resource cost estimate for implementing the mitigation technique across the population of devices; identify a subset of kill chains, in the set of kill chains, containing a node associated with a vulnerability module indicating the mitigation technique; calculate a risk reduction value for the mitigation technique based on a combination of composite kill chain scores for the subset of kill chains; calculate a normalized risk reduction value for the mitigation technique, executed across the population of devices, based on the risk reduction value and the resource cost estimate; identify a particular mitigation technique, in the set of mitigation techniques, associated with a greatest normalized risk reduction value; identify a subset of devices, in the population of devices, associated with kill chains containing nodes associated with vulnerability modules indicating the mitigation technique; generate a prompt to execute the particular mitigation technique on the subset of devices; and serve the prompt to security personnel affiliated with the computer network.

For example, the system can generate the set of kill chain graphs including, for a first kill chain graph associated with a first device and a second kill chain graph for a second device: identifying a first node in a first kill chain graph for the first device association with a first output node and a second node a second kill chain graph for the second device with a second input node, the first output node enabling the first input node; and deriving a connection (or “edge”) between the first node and the second node representing a connection between the first device and the second device. The system can then implement methods and techniques as described herein to identify (and sort) an optimal mitigation technique for vulnerability remediation resulting in the greatest amount of risk reduction.

Accordingly, the system can: identify vulnerabilities that can enable lateral movement between kill chains (e.g., from a first device to a second device on the computer network); and identify mitigation technique(s) to prevent lateral movement, thereby decreasing a likelihood of that vulnerability (or an associated kill chain) from being exploited by a bad actor by removing the vulnerability.

### 8. Variation: Top-down Kill Chain Construction

In one variation, the system can: populate a kill chain graph with a constellation of nodes representing the set of vulnerability modules; sort the constellation of nodes into tiers based on access tier defined in corresponding vulnerability modules in the set of vulnerability modules; selectively connect nodes in the kill chain graph with edges based on alignment of input vulnerabilities and output vulnerabilities, defined in corresponding vulnerability modules in the set of vulnerability modules, of nodes in adjacent tiers in the kill chain graph; and identifying a set of kill chains, each kill chain defining a unique continuous pathway through the kill chain graph.

In this variation, the system can then: select a device on a network (e.g., an organization computer network); access a set of device characteristics (e.g., device type, applications, internet connection, software, firmware); and filter the kill chain graph based on the set of device characteristics.

More specifically, the system can: access a set of device characteristics for a first device on a computer network including a device configuration; access the set of vulnerabilities including vulnerability modules defining device inclusion characteristics; identify a first vulnerability in the set of vulnerabilities defining a first set of device inclusion characteristics; and in response to the set of device characteristics exhibiting the first set of device inclusion characteristics, include a first node representing the first vulnerability in a first potential kill chain associated with the first device. Similarly, the system can: identify a second vulnerability in the set of vulnerabilities defining a set of device exclusion characteristics; and, in response to identifying the presence of a device exclusion characteristic, in the set of device characteristics for the first device, excluding the second vulnerability from a first potential kill chain associated with the first device.

The system can implement methods and techniques described herein for each vulnerability in the set of vulnerabilities to generate a template kill chain graph from a set of potential kill chains for the first device.

The system can then, at a second time following generation of the template kill chain graph: access a subset of vulnerabilities present on the first device, such as from sensor data on the first device; and, in response to identifying the absence of a first vulnerability in the subset of vulnerabilities, removing the first node representing the first vulnerability from the template kill chain graph.

Therefore, the system can: generate a kill chain graph representing every possible kill chain from the set of vulnerabilities; generate a template kill chain graph for each device on a network of devices based on device characteristics; and filter the template kill chain graph based on vulnerabilities identified on the device to generate a first kill chain graph for the first device. The system can then implement methods and techniques described herein to identify and recommend a mitigation technique to a user for vulnerability remediation to reduce a risk associated with the vulnerability and an associated kill chain.

### 9. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a corpus of threat intelligence representing a set of vulnerabilities and a set of attack techniques; and,
for each vulnerability in the set of vulnerabilities:
deriving a correlation between the vulnerability and an attack technique, in the set of attack techniques, based on language signals detected in descriptions of the vulnerability and the attack technique;
constructing a vulnerability module, in a set of vulnerability modules, defining the attack technique and representing the vulnerability; detecting a second vulnerability, in the set of vulnerabilities, preceding exploitation of the vulnerability in the corpus of threat intelligence;
defining the second vulnerability as an input vulnerability in the vulnerability module;
detecting a third vulnerability, in the set of vulnerabilities, succeeding exploitation of the vulnerability in the corpus of threat intelligence;
defining the third vulnerability as an output vulnerability in the vulnerability module;
interpreting an access tier of the vulnerability based on characteristics of the attack technique correlated with the vulnerability;
accessing a vulnerability risk score for the vulnerability from the corpus of threat intelligence;
interpreting a mitigation technique for the attack technique from the corpus of threat intelligence;
deriving a set of device inclusion characteristics correlated with exploitation of the vulnerability via the attack technique from the corpus of threat intelligence; and
annotating the vulnerability module with the access tier, the vulnerability risk score, the mitigation technique, and the set of device inclusion characteristics.
